(19) United States
(12) Patent Application Publication
(10) Pub. No.: US 2015/0293295 A1
(43) Pub. Date: Oct. 15, 2015

(54) FLAT PANEL LAMP

(71) Applicant: ProRadiant Opto Co., Ltd., Taoyuang County (TW)

(72) Inventor: CHAO-PING WANG, Taoyuang County (TW)

(73) Assignee: ProRadiant Opto Co., Ltd., Taoyuang County (TW)

(21) Appl. No.: 14/250,525

(22) Filed: Apr. 11, 2014

(51) Int. Cl. F21V 8/00

(52) U.S. Cl. CPC G02B 6/0035; G02B 6/0073

(57) ABSTRACT

A flat panel lamp according to the invention comprises a light guide structure, at least a reflector member, at least a diffusion member and a light source module. The light guide structure has a bottom surface, an illuminating surface corresponding to the bottom surface, and a side surface located between the bottom surface and the illuminating surface. The reflector member is located at the bottom surface of the light guide structure. The diffusion member is located between the light guide structure and the reflector member. The light source module is located at the side surface of the light guide structure. The problem of non-uniform brightness can be resolved by the diffusion member, and the luminance intensity of the whole flat panel lamp can also increased.

### BACKGROUND OF THE INVENTION

1. Field of the Invention

The invention relates to an improved flat panel lamp, and more particularly to an improved flat panel lamp capable of solving the problem of non-uniform brightness and increasing the illumination intensity as well.

2. Description of the Related Art

According to evolution of advanced technology, many industrial products are designed toward lightweight and thinner thickness to reduce weight and thickness of the products, wherein the practicability of light emitting diodes (LEDs) is widely applied and can be produced into liquid crystal televisions and indoor illumination lamps. A LED light plate as one wide application is to arrange a plurality of LED lamp holders as an array in a lamp housing and to dispose a correspondingly driving circuit in the lamp housing. This kind of the structure is simple and practicality. However, the LED light plate adopts direct-type luminous form that offends to the eyes, and uniformity of emitted light beam is poor (the uniformity is smaller 70%). To solve the foregoing issue, a type of LED flat lamp is developed.

The LED flat lamp is a plane shape, and components disposed therein are also planer shape. As shown in FIG. 1, a plane light guide plate 12 is mainly disposed in a bottom plate 11, and a LED lamp strip 13 is disposed at a side of the light guide plate 12. Under the affecting of the light guide plate 12, light beam can be reflected for many times to achieve the purpose of uniformity and prevents glare.

However, the size of the light guide plate inside the LED flat lamp is large and can be easily deformed. In the example shown in the figure, the warped portions 121 are formed. The warped portions 121 would change light beam path to form a dark region to affect the light beam performance of the LED flat lamp.

### SUMMARY OF THE INVENTION

Therefore, upon the foregoing problems, it is a primary objective of the present invention to provide an improved flat panel lamp capable of solving the problem of non-uniform brightness and increasing the luminance intensity of the whole flat panel lamp as well.

To achieve the foregoing objective, the flat panel lamp according to the invention comprises a light guide structure, at least a reflector member, at least a diffusion member and a light source module. The light guide structure has a bottom surface, an illuminating surface corresponding to the bottom surface and a side surface located between the bottom surface and the illuminating surface. The reflector member is located at the bottom surface of the light guide structure. The diffusion member is located between the light guide structure and the reflector member. The light source module is located at the side surface of the light guide structure.

By utilizing the diffusion member, the problem of non-uniform brightness can be solved, and luminance intensity of the whole flat panel lamp can also be increased.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a structure cross-sectional drawing of a conventional light emitting diode flat lamp;

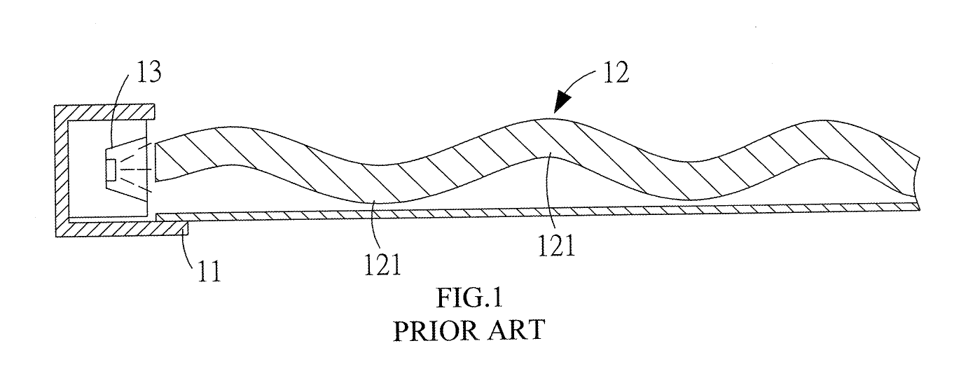

FIG. 2 is a structure three-dimensional drawing of a flat panel lamp according to the invention;

FIG. 3 is a structure decomposition drawing of a flat panel lamp according to the invention;

FIG. 4 is a structure cross-sectional drawing of a flat panel lamp according to the invention;

FIG. 5 is another structural three-dimensional drawing of a flat panel lamp according to the invention.

### DETAILED DESCRIPTION OF THE PREFERRED EMBODIMENTS

The technical content of the present invention will become apparent by the detailed description of the following embodiments and the illustration of related drawings as follows.

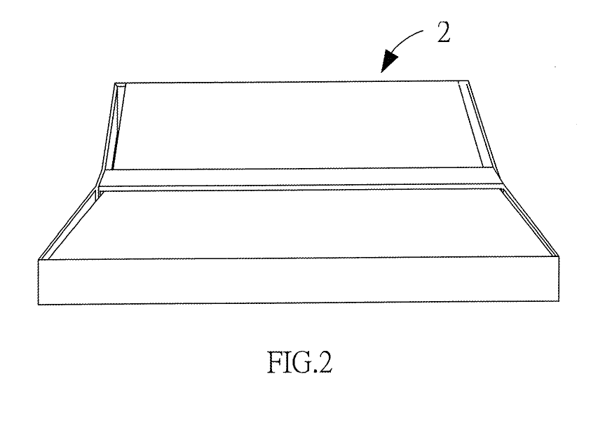

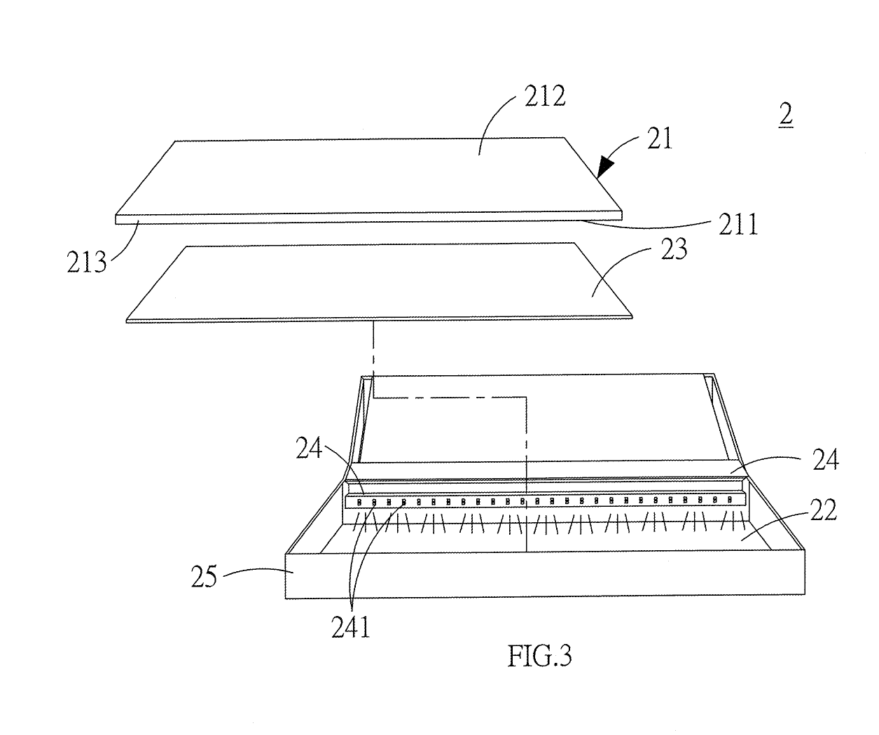

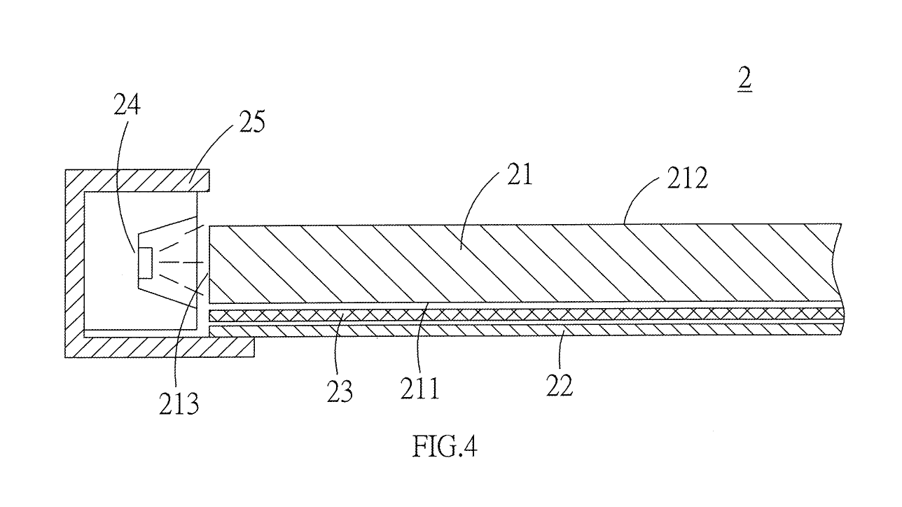

With reference to FIG. 2, FIG. 3 and FIG. 4 for a structural three-dimensional drawing of a flat panel lamp according to an invention, a structural decomposition drawing of a flat panel lamp according to an invention and a structure cross-sectional drawing of a flat panel lamp according to an invention are depicted. The flat panel lamp 2 according to the invention comprises: a light guide structure 21, at least a reflector member 22, at least a diffusion member 23, a light source module 24 and a frame body 25.

The light guide structure 21 has a bottom surface 211, an illuminating surface 212 corresponding to the bottom surface 211, and a side surface 213 between the bottom surface 211 and the illuminating surface 212. In the embodiment shown in the figure, four side surfaces 213 are between the bottom surface 211 and the illuminating surface 212 of the light guide structure. The illuminating surface of the light guide structure is further disposed with a lamp housing (not shown in the figure).

The reflector member 22 is at the bottom surface 211 of the light guide structure 21. The reflector member 22 can be a reflection sheet, a reflection panel or a backboard of the flat panel lamp.

The diffusion member 23 is located between the light guide structure 21 and the reflector member 22.

The light source module 24 is located at one of the side surfaces 213 of the light guide structure 21. The light source module 24 further has a plurality of light emitting diodes 241. As show in the embodiment, the light emitting diodes 241 can also be located at other side surfaces of the light guide structure.

The frame body 25 is used for fastening the light guide structure 21, the reflector member 22, the diffusion member 23 and the light source module 24.

The light source of the light source module 24 enters from the side surface 213 of the light guide structure. Under co-acting of the light guide structure 21 and the reflector member 22, light beam is reflected for many times to achieve the purpose of enhancing uniform degree and can prevent glare. Moreover, by utilizing the diffusion member 23 disposed between the light guide structure 21 and the reflector member 22, light beam diffusion can be increased. Even if the light guide structure 21 is deformed and bent because of large size, the problem of non-uniform brightness can be overcome by utilizing diffusion of the diffusion member 21. The luminance intensity of the whole flat panel lamp can also be increased.

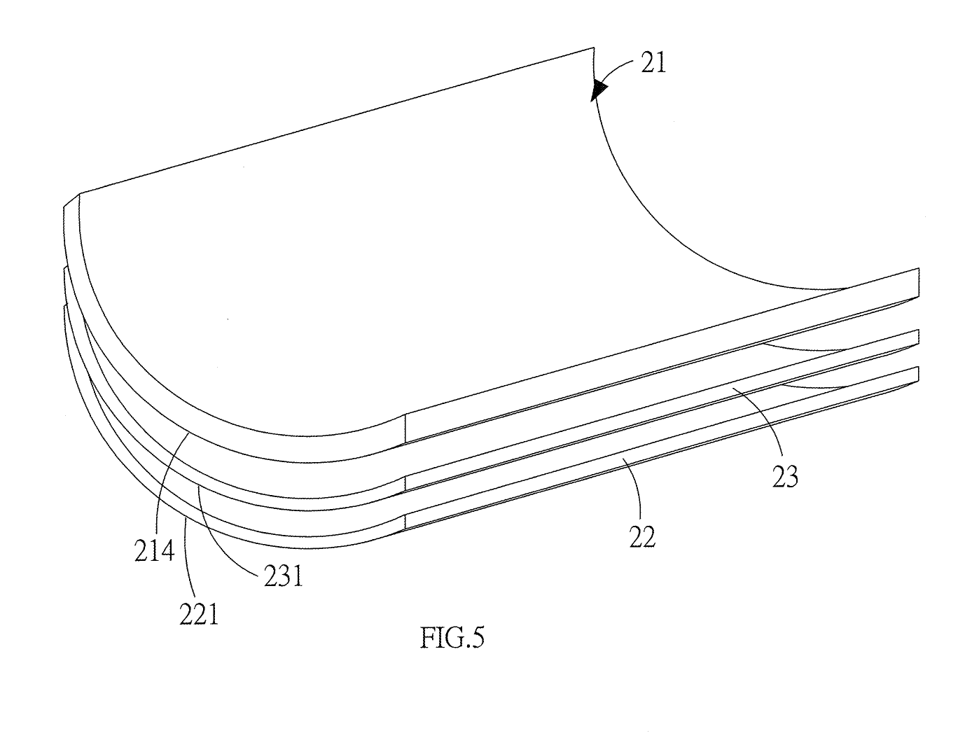

Further, with reference to FIG. 5 for another embodiment, the light guide structure 21 has at least a protrusion portion 214 along arranged along a first direction. The reflector member 22 has at least a convex portion 221 arranged along a first direction. The diffusion member 23 has at least a convex portion 231 arranged along a first direction so as to form the flat panel lamp having different shapes.

Therefore, the invention provides a preferable and feasible improved flat panel lamp. While the means of specific embodiments according to the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An improved flat panel lamp comprising:
a light guide structure having a bottom surface, an illuminating surface corresponding to the bottom surface and side surfaces located between the bottom surface and the illuminating surface;
at least a reflector member located at the bottom surface of the light guide structure;
at least a diffusion member located between the light guide structure and the reflector member; and
a light source module located at the side surface of the light guide structure.

2. The improved flat panel lamp of claim 1, wherein the light guide structure has at least a protrusion portion arranged along a first direction, and the reflector member has at least a convex portion arranged along the first direction, and the diffusion member has at least a convex portion arranged along the first direction.

3. The improved flat panel lamp of claim 1, wherein the reflector member is a backboard of the flat panel lamp.

4. The improved flat panel lamp of claim 1, wherein four side surface are disposed between the bottom surface and the illuminating surface of the light guide structure, and the light source module is located at one of the side surfaces.

5. The improved flat panel lamp of claim 1, wherein the light source module is further disposed with a plurality of light emitting diodes.

6. The improved flat panel lamp of claim 1, wherein the illuminating surface of the light guide structure is further disposed with a lamp housing.
